(19) United States
(12) Patent Application Publication
(10) Pub. No.: US 2016/0029693 A1
(43) Pub. Date: Feb. 4, 2016

(54) SYSTEMS AND METHODS FOR MOBILE SOFTWARE CLINICAL SMOKING CESSATION PLATFORM

(71) Applicant: Click Therapeutics, Inc., New York, NY (US)

(72) Inventors: David Benshoof Klein, New York, NY (US); Joshua R. Steinerman, Philadelphia, PA (US); Victor Gao, New York, NY (US); Bruce Leuchter, New York, NY (US); Michael McAllister, Miami Beach, FL (US); Wei Zhou, New York, NY (US); Chris Cicero, New York, NY (US)

(21) Appl. No.: 14/221,517

(22) Filed: Mar. 21, 2014

Related U.S. Application Data
(60) Provisional application No. 61/804,016, filed on Mar. 21, 2013.

(51) Int. Cl. A24F 47/00; G06F 3/16; G08B 7/06

(52) U.S. Cl. CPC A24F 47/002; G08B 7/06; G06F 3/167

(57) ABSTRACT

The object of the present invention is to provide a system and method to enable a person wishing to quit smoking to carry with him a smoking cessation device that will assist the user in behavior modification, and in particular curbing and dealing with nicotine cravings. The current invention makes use of widely available and familiar infrastructure of hand held devices such as cellular phones and cellular networks. Other mobile devices having digital displays may also be used such as mobile touchscreens (i.e. Ipad, Kindle, etc.) digital music players such as the iPod and other similar devices. Smoking cessation and craving reduction are achieved through coordinated messaging reinforcement coupled with craving reduction training including controlled deep breathing exercises prompted by the device.

### CROSS-REFERENCE TO RELATED APPLICATIONS

This application claims the benefit of and priority to U.S. Provisional Patent Application No. 61/804,016 for “MOBILE SOFTWARE CLINICAL SMOKING CESSATION PLATFORM”, filed on Mar. 21, 2013, which is incorporated herein by reference in its entirety for all purposes.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the field of software. More particularly, the present invention is in the technical field of software assisting users achieve behavioral modification (smoking cessation).

### BACKGROUND OF THE INVENTION

Each year millions of people resolve to quit smoking. However, there are very few non-chemical options for quitting smoking. This medium is mobile, unique, and is totally non-chemical.

Current mobile technologies promoting smoking cessation are limited to informational applications (i.e. reference materials for quitting smoking, such as general health information) and messaging applications that send text messages or other messages to users encouraging them to quit smoking.

These mobile technologies related to quitting smoking employ only a narrow subset of all the strategies available, and no solutions in the marketplace have been developed to reduce nicotine cravings by developing cognitive digital tools.

### SUMMARY OF THE CURRENT INVENTION

The present invention relates to a system and method to enable a person wishing to quit smoking to carry with him a device to facilitate smoking cessation. In some embodiments, the invention provides brain-based interactive mechanisms across a number of sensory modalities to facilitate smoking cessation, reduced cravings and prevent relapse. User's cravings are addressed through combinative, guided, cognitive therapies, including a virtual cigarette designed to re-create sensorimotor pleasures associated with smoking, deep breathing exercises that reduce cravings and automated targeted messages educating users about the quitting process and reinforcing successful quitting strategies. Additionally, detailed user data gathered by the application reinforces the benefits of behavioral change—including temporal, monetary, health & wellness improvements.

In some embodiments, the inventive method and system is easy to use and requires little preparation or effort by the user. In some embodiments, the method and system uses widely used and familiar infrastructure of hand held devices such as cellular phones and cellular networks. Other digital handheld devices with wireless connections to the internet such as iPads, Kindles and some portable music players such as iPods and other similar touch screen devices could be used. Such devices may be easily carried by a user and used for smoking cessation anywhere.

Alternatively, a digital handheld device could be replaced by a large screen display such as a television, a laptop computer or a personal computer in such situations where mobility is not important.

The inventive method is easily implemented and may be used widely.

In an embodiment of the invention, a platform for smoking cessation comprises a handheld device wirelessly connected to one or more server computers. The hand held device comprises a display for displaying visual stimuli, speakers to produce audible sounds and means for input such as a touchscreen keypad for providing feedback from the user to the server.

The method of using the handheld device for smoking cessation comprises the following steps which will be familiar to anyone with a smart phone: (a) loading the application on the handheld device; (b) opening the application and registering an account or connecting an existing account; and (c) running the application program on the handheld device.

One aspect of the application is a screen utilizing a virtual cigarette designed to re-create sensorimotor pleasures associated with smoking, combined with guided deep breathing exercises that reduce cravings and automated executive and motivational notifications.

In one embodiment, a haptic control bar rests over a picture of a cigarette, and moves up and down to the sound of breathing in a controlled manner designed to guide a user to breathe deeply and enter a state of relaxation. In some embodiments, a timer indicates the amount of time elapsed and/or remaining in the exercise, while the application separately states the pace of breaths per minute.

Another aspect of the application is reinforcement messaging, which is sent to the application via remote server over wireless networks. Such messages are well known to users of smart phones and cellular phone users.

In one embodiment, such messages are delivered by system notifications loaded onto the handheld device's system tray. A user can interact with these notifications by touching them, reading the contents, and providing feedback on a message's efficacy and usefulness.

Another aspect of the application includes progress tracking. In one embodiment the application reports application usage to the remote server via wireless network. As usage is tracked, the server populates fields within the application based upon pre-determined formulas such as cost savings achieved by smoking cessation, increases in expected life expectancy and basic usage tracking statistics.

In one embodiment, such information is transferred between the mobile handheld device and the server via a mobile network. In another embodiment, such information is transferred over high speed line based internet not requiring connection to a mobile phone network.

Yet another aspect of the application includes profile tracking in which a user utilizes the keypad to provide answers to questions delivered to the mobile handset from the server. Based upon these answers, the server populates profile information such as the users customary smoking habits, personal information such as age and other information. This information may be combined with information automatically gathered by the application such as location data, usage information, etc.

In sum, in some implementations, the application provides an opportunity for a user to facilitate smoking cessation and control cravings. Brain-based user interactions feature therapeutic functions, including controlled deep breathing, targeted motivational and executive notifications, as well as additional contextual information compiled over time and through the user's input.

In some embodiments, the present invention relates to a system and method to enable a person wishing to quit smoking to carry with him a smoking cessation device that will assist the user in behavior modification, and in particular curbing and dealing with nicotine cravings. In some implementations, the current invention makes use of widely available and familiar infrastructure of hand held devices such as cellular phones and cellular networks. Other mobile devices having digital displays may also be used such as mobile touchscreens (i.e. Ipad, Kindle, etc.) digital music players such as the iPod and other similar devices. Smoking cessation and craving reduction are achieved through coordinated messaging reinforcement coupled with craving reduction training including controlled deep breathing exercises prompted by the device.

In some implementations, a mobile smoking cessation application assisting users to quit smoking through four primary components: a digital de-nicotinized cigarette with simultaneous controlled deep breathing led by a haptic-input control bar and breathing sound effects for guidance, reinforcement messaging, and real-time metrics which approximate life-years preserved and money saved.

In some implementations, the invention provides a brain-based user experience, delivering contextualized interactions based on individual profile and preference. Underlying the application is a simplified, actionable heuristic model of cognitive-behavioral change guiding the delivery of smoking cessation content through two types of cognitive feedback: executive and motivational. Executive control is empowered when users formulate goals and strategies, make decisions, and effectively self-regulate. An ascending pathway corresponding to motivation is activated when users initiate and maintain desired behaviors, experience pleasure, and receive rewards.

Sensorimotor pleasures of smoking are coupled with non-nicotine reinforcers to induce neuroplastic change and promote goal-attainment. A conventional cigarette is a powerful system to deliver rapid, self-titrated doses of nicotine to the human brain. However, smoking addiction is also sustained by non-nicotinic mechanisms as well. Sensorimotor experiences (e.g. mouth, hand, lung, visual, olfactory, etc.) provide significant reinforcement when coupled with nicotine surges. The invention repeatedly exposes the user to non-nicotinic stimuli (sounds of a cigarette, visual representation of a cigarette, controlled deep breathing) to reinforce sensorimotor pleasures of smoking, mitigate cravings, and increase the likelihood of nicotinic uncoupling.

Through this medium, both the executive and motivation systems are systematically engaged through the multiple interaction modalities described, allowing users to remain calm and to control and systematically reduce and respond to cravings.

### BRIEF DESCRIPTION OF EXEMPLARY EMBODIMENT

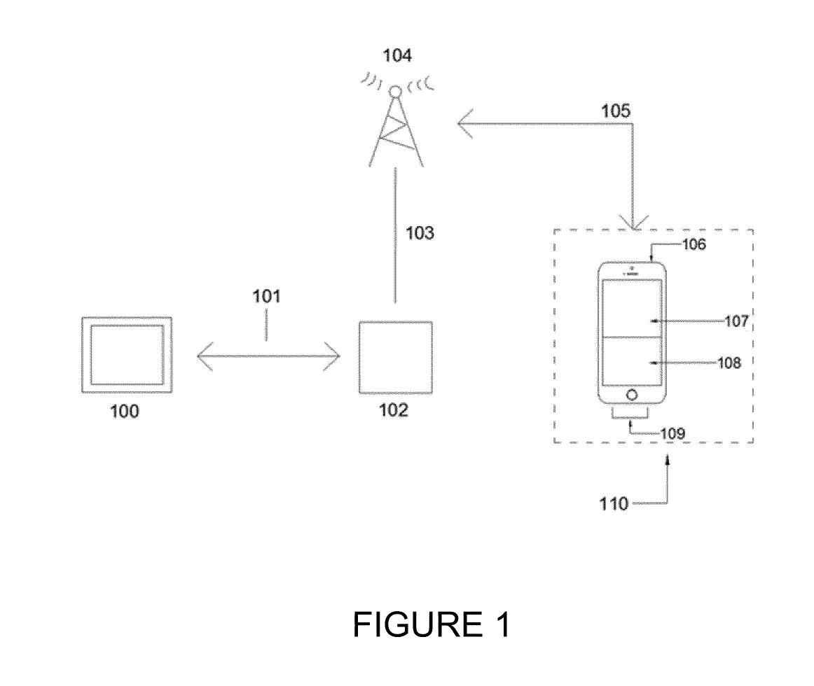

FIG. 1 shows a system for smoking cessation by presenting on a handheld display unit an application offering users guided deep breathing exercises, audio and visual stimuli simulating various aspects and sensorimotor pleasures associated with smoking as well as targeted notifications and profile tracking according to an exemplary embodiment of the invention.

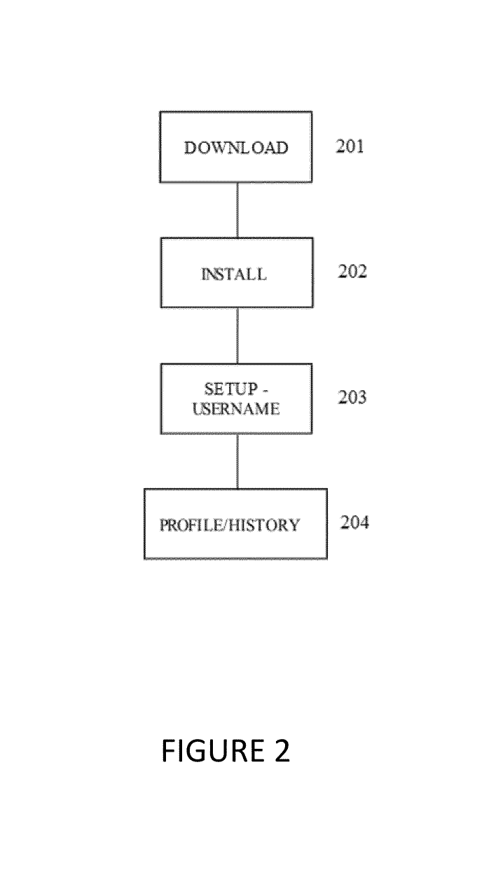

FIG. 2 is an illustration of an embodiment of the process for installing the application and performing initial setup.

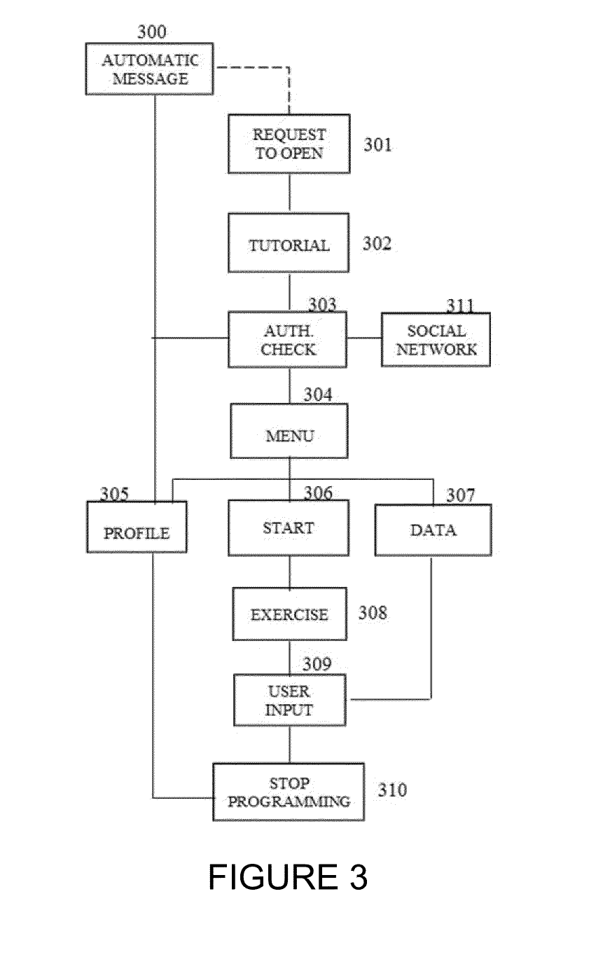

FIG. 3 is an illustration of an embodiment of smoking cessation application.

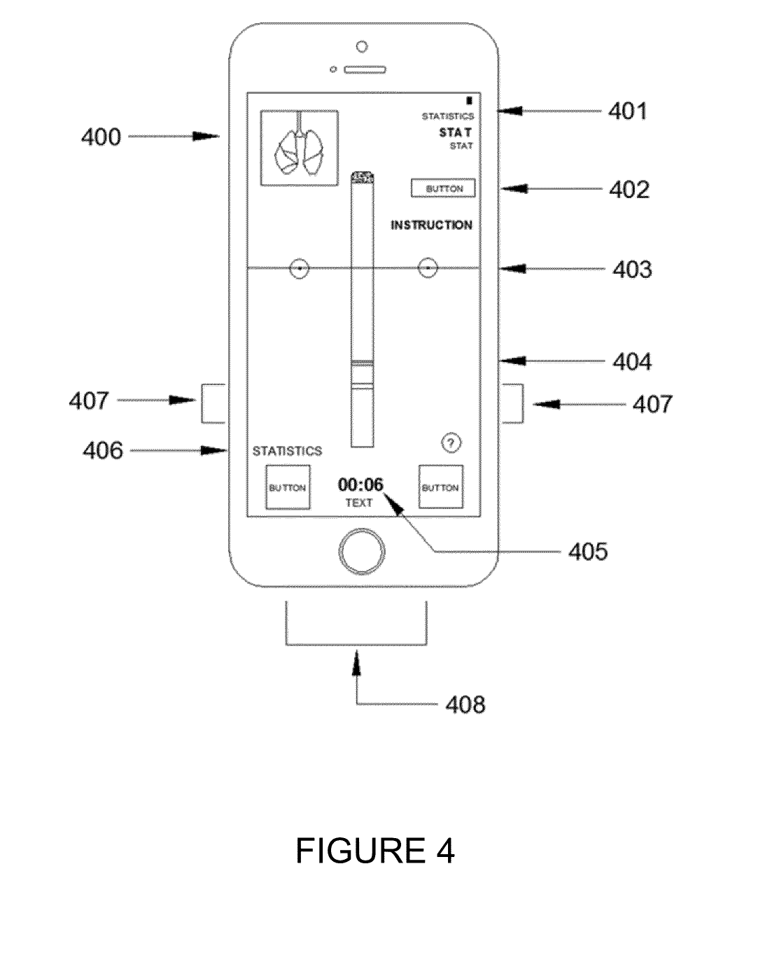

FIG. 4 is an illustration of an embodiment of the visual and sonic stimulation for guided deep breathing aspect of the application.

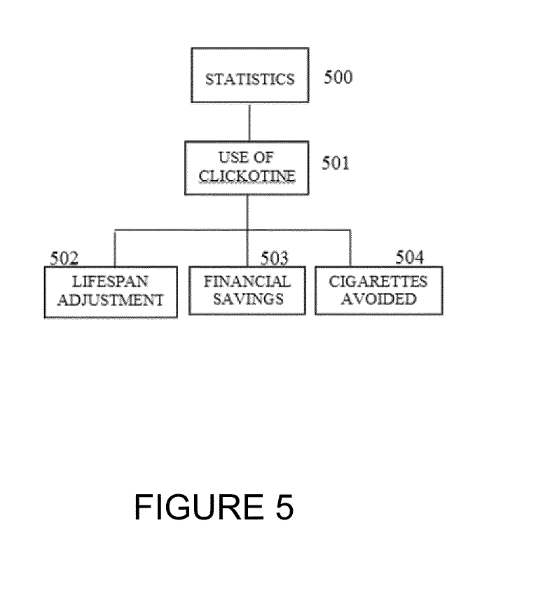

FIG. 5 is an illustration of an embodiment of the data collection aspect of the application.

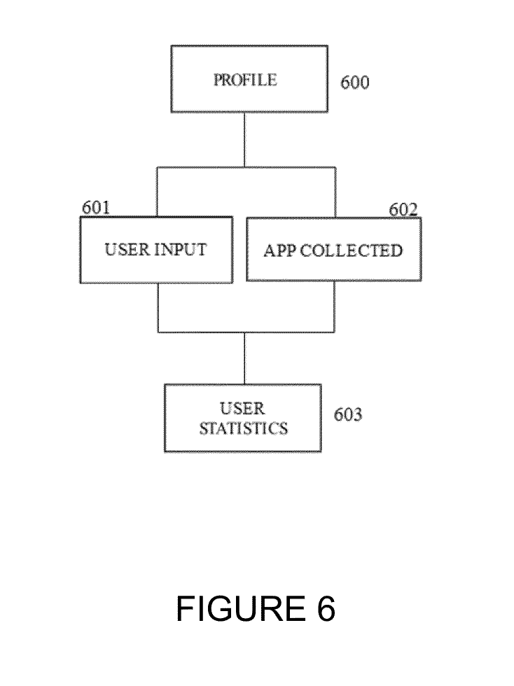

FIG. 6 is an illustration of an embodiment of the profile population of the application.

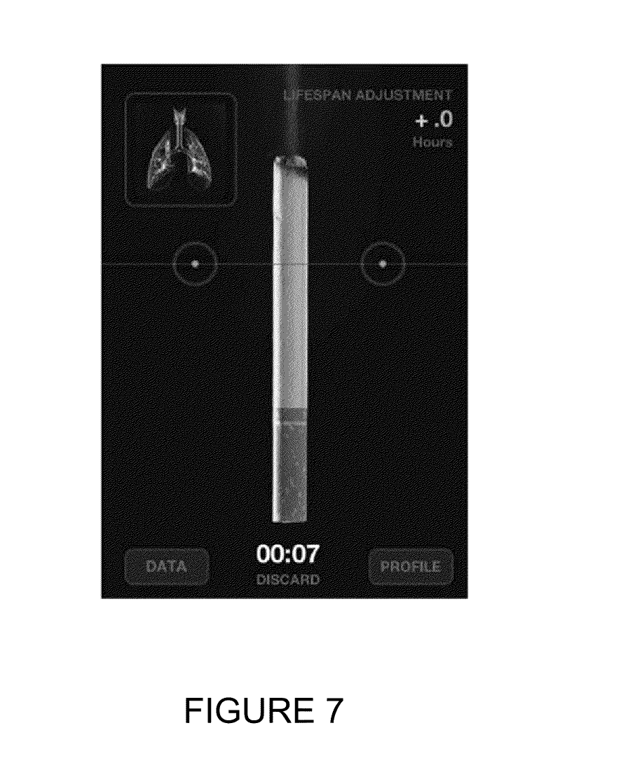

FIG. 7 is a graphical representation of a smart phone interface illustrating a de-nicotinized virtual cigarette with haptic input guided deep breathing control bar, breath capacity representation and timer.

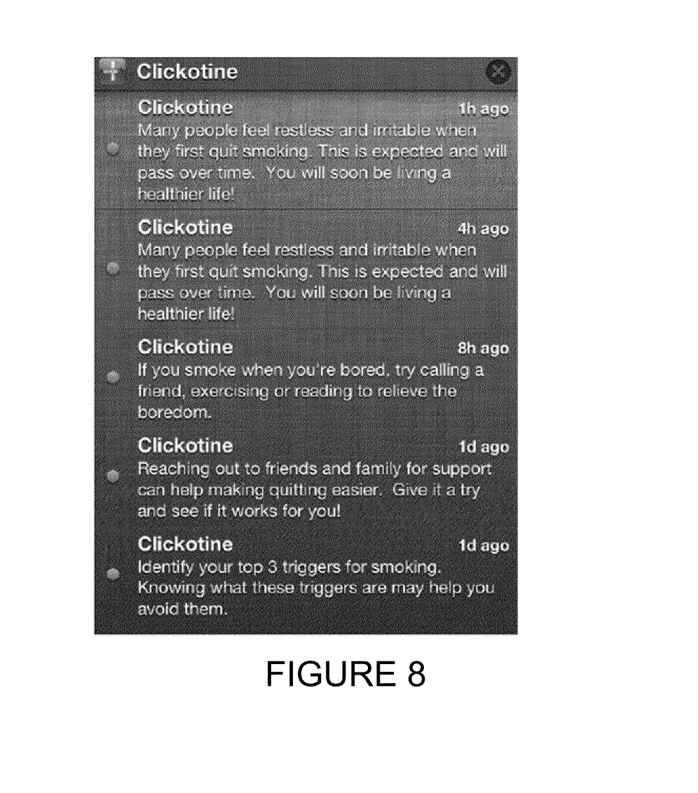

FIG. 8 is a graphical representation of a smart phone interface displaying examples of automated tailored contextualized reinforcement text messages delivered to the smart phone interface.

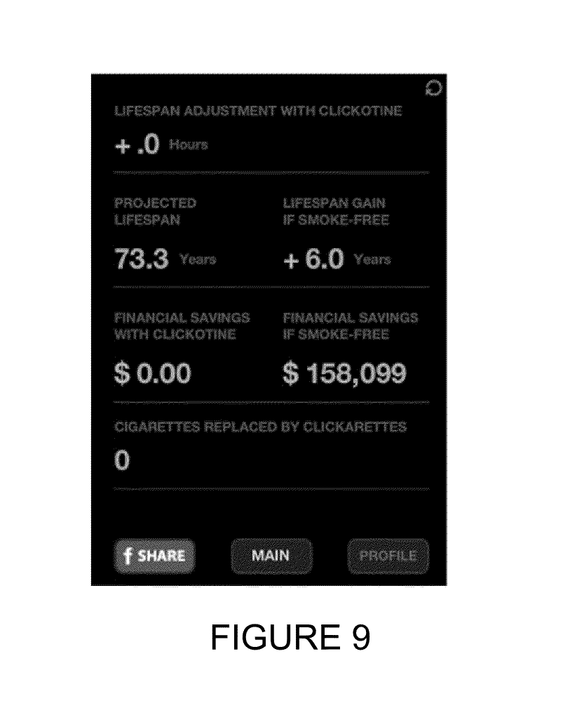

FIG. 9 is a graphical representation of a smart phone interface representing reinforcing statistics calculated from individual user data with underlying formulas drawn from population data.

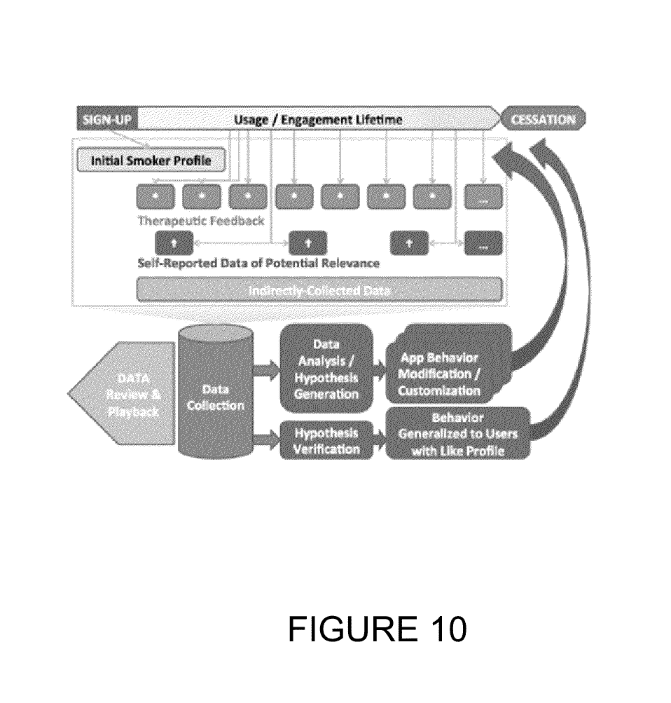

FIG. 10 is an illustration of underlying data platform that includes application data collection flow, data analysis and hypothesis verification, and data utilization to create application behavior modification, application customization, and therapeutic feedback.

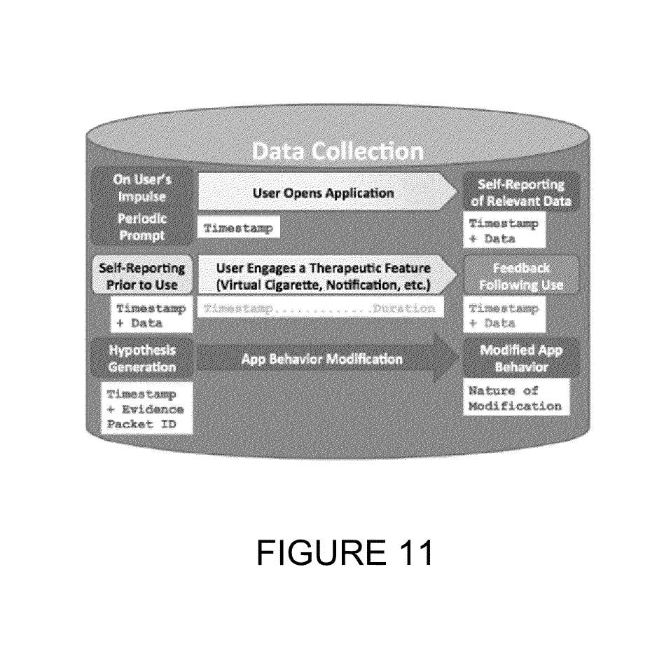

FIG. 11 is an illustration of multi-channel application data collection process with timestamp.

### DETAILED DESCRIPTION OF THE INVENTION

In some implementations, the medium is a software invention utilizing computer programming replicated across any of a number of platforms and is readily understandable and replicated by anyone skilled in the art of computer programming. In some implementations, the invention is a smart phone application assisting users to quit smoking through four primary components: a digital de-nicotinized cigarette (404) with simultaneous controlled deep breathing led by a haptic-input control bar (403) and breathing sound effects (408) for guidance, targeted notifications (400), and real-time metrics which estimate life-years preserved (401) and money saved (503). The application is created through software code and is readily understandable and replicated by anyone skilled in the art of computer programming.

Referring now to FIG. 2, the software is installed in a manner that is familiar to any user of a hand held computing device. Software is downloaded (201) via network (105) and installed as any other application on the device (202). Upon startup a user is prompted to create a user name and security password (203) and has an opportunity to create a user profile (204), as is described more particularly in FIG. 6 and below.

Referring now to FIG. 4, there is shown a representation of the de-nicotinized cigarette (404) with haptic input guided deep breathing control bar (403), breath capacity representation (400) and timer (405). The de-nicotinized cigarette (404) is ignited by the user upon a touch screen interface (107) and the sound and visualization of a lit cigarette manifest within the medium. When lit, the end of the cigarette (404) flames to the sound (408) of a striking match, with the flame slowing dying down to a slow burn, as happens with a traditional cigarette. The haptic control bar (403) raises and lowers to the sound (408) of deep breathing, leading the user through a controlled deep breathing exercise. The haptic control bar line (403) moves lower as the user inhales and the breath capacity representation (400), in one embodiment a graphic of human lungs, change color as a representation of air moving into or out of the users' lungs. When exhaling, the haptic control bar (403) moves upward signaling exhaling and the color disappears. Haptic interactions with the moving line itself encourage sensorimotor engagement and provide motor measures of user adherence. In one embodiment, the haptic control bar (403) can be self-guided (i.e. controlled by the user via touch screen) or computer controlled. A timer (405) at the bottom of the representation informs a user as to the total time spent during the deep breathing exercise. During the exercise, the user is able to see statistics (401) concerning his or her usage of application. These applications are created through software code, and the process for doing so is readily understandable and replicated by anyone skilled in the art of computer programming.

As described in FIG. 5, statistics (500) are created automatically based upon application usage (501) which enables the application to determine the total number of cigarettes avoided (504), financial savings to the user (503) and lifespan adjustment (502).

Referring now to FIG. 3, there is shown a representation of messages delivered to the application. In one embodiment, Messages (300) are delivered by system notifications loaded onto the handheld device's system tray. A user can interact with these notifications by touching them, reading the contents, and providing feedback on a message's efficacy and usefulness. The messages are delivered over mobile network (105) from the server (100) at time intervals specified by the user, or by default, to correlate with anticipated craving windows.

Referring now to FIG. 6, there is shown a representation of a user profile that is maintained within the application illustrating figures essential to smoking cessation reinforcement. These figures are divided between user inputted data (601) and application collected data (602). In one embodiment of the application, statistics generated by the server (100) would include cost savings achieved, extension of life and the number of de-nicotinized cigarettes utilized. All functional aspects of a user's engagement with the platform will be stored on the server (100) and are available for review and playback by the user and/or a health professional. In one embodiment this information would be displayed on a mobile handheld screen (107) in other embodiments the data could be displayed on a personal computer or other device connected to the server (100) via the internet. This includes data collected before and after the user engages with one of the platform's various therapeutic features, e.g., virtual cigarette (404), deep breathing controls (403), system notification (300), etc. It includes data elicited from the user (601) spontaneously and data periodically solicited from the user. Time-varying effects are modeled statistically within-person coupling and uncoupling of behavioral state and application usage, actual cigarette smoking, cravings, stress levels. In one embodiment it includes the totality of times when the platform initiates a customization over the baseline behavior for the user based on data collected from him or her to date.

Referring now to FIG. 1, there is shown a representation of data flow between the mobile handheld device (110) and back end servers (100) monitoring usage data such as in one embodiment, location information and other data useful to analyzing user behavior and improving profile responsiveness. The System in FIG. 1 can include client handheld or computer mediums, a location networking system (105), and back-end networking system (100, 101, 102). The hand held client (110) and back-end system (100) can each have a corresponding data store such as local storage medium, location data storage medium and back-end system data storage. The client system can communicate with location networking system to receive messages, location information, etc. Additionally, the back-end system can transmit data (101) to and receive data the handheld client. Each system can communicate HTTP packets including data requests, transaction information, updates, etc. Communication can occur over any appropriate electronic communication medium or network using any suitable communications protocols; in one embodiment it flows over a mobile network (105). One skilled in the art would appreciate that these are presented merely as an example of a data flow between various types of online systems.

However, the present disclosure is intended to encompass data flows between a local client and a variety of other online systems including back end data servers. The example data flows described herein function analogously with these online systems as with location networking systems. The creation of such interactions is created by software code in any number of formats, all of which are readily understandable and replicated by anyone skilled in the art of computer programming.

Referring now to FIG. 7, there is shown a representation of the de-nicotinized cigarette with haptic input guided deep breathing control bar, breath capacity representation and timer. The de-nicotinized cigarette is ignited by the user upon a touch screen interface and the sound and visualization of a lit cigarette manifest within the medium. When lit, the end of the cigarette flames to the sound of a striking match, with the flame slowing dying down to a slow burn, as happens with a traditional cigarette. The haptic control bar raises and lowers to the sound of deep breathing, leading the user through a controlled deep breathing exercise. The line moves lower as the user inhales and the breath capacity representation (a graphic of human lungs) change color as a representation of air moving into or out of the users' lungs. When exhaling, the haptic control bar moves upward signaling exhaling and the color disappears. Haptic interactions with the moving line itself encourage sensorimotor engagement and provide motor measures of user adherence. The control bar can be self-guided (i.e. controlled by the user via touch screen) or computer controlled. A timer at the bottom of the representation informs a user as to the total time spent during the deep breathing exercise.

Referring now to FIG. 8, there is shown a representation of messages delivered to the application. Messages are sent to the application via SMS/MMS or any other similar messaging technology (such as MMS, e-mail, etc.) and other forms of communication readily available and replicated by anyone skilled in the art of computer programming. The messages are delivered at time intervals specified by the user, or by default, to correlate with anticipated craving windows.

Referring now to FIG. 9, there is shown a representation of a user profile that is maintained within the application illustrating figures essential to smoking cessation reinforcement such as cost savings achieved, extension of life, number of de-nicotinized cigarettes utilized, etc. As FIG. 9 illustrates, functional aspects of a user's engagement with the platform will be stored and available for review and playback by the user and/or a health professional. This can include data collected before and after the user engages with one of the platform's various therapeutic features, e.g., virtual cigarette, deep breathing, messaging, system notification, etc. It can also include data solicited from the user automatically, impulsively and periodically relating to aspects of his or her experience which may bear relevance to his or her journey towards full cessation, e.g., real cigarette usage, cravings, stress levels. And it includes an accumulation of modifications made when the platform initiates a customization over the baseline behavior for the user based on data collected from him or her to date.

Referring now to FIG. 10 and FIG. 11, there is shown a representation of data flow between the application and back end servers monitoring usage data, location information and other data useful to analyzing user behavior and customizing the application's therapeutic offerings and interface. The system can include client handheld or computer mediums, a location networking system, and back-end networking system. The client system and back-end system can each have a corresponding data store such as local storage medium, location data storage medium and back-end system data storage. The client system can communicate with location networking system to receive messages, location information, etc. Additionally, the back-end system can transmit data to and receive data (e.g. de-nicotinized cigarette usage information, location information, profile information, application interaction data, etc.) from client system. Each system can communicate HTTP packets including data requests, transaction information, updates, etc. Communication can occur over any appropriate electronic communication medium or network using any suitable communications protocols. One skilled in the art would appreciate that these are presented merely as an example of a data flow between various types of online systems. However, the present disclosure is intended to encompass data flows between a local client and a variety of other online systems including back end data servers.

In some embodiments, the invention provides a brain-based user experience, delivering contextualized interactions based on individual profile and preference. Underlying the application is a simplified, actionable heuristic model of cognitive-behavioral change guiding the delivery of smoking cessation content through two types of cognitive feedback: executive and motivational. Executive control is empowered when users formulate goals and strategies, make decisions, and effectively self-regulate. An ascending pathway corresponding to motivation is activated when users initiate and maintain desired behaviors, experience pleasure, and receive rewards.

Sensorimotor pleasures of smoking are coupled with non-nicotine reinforcers to induce neuroplastic change and promote goal-attainment. A conventional cigarette is a powerful system to deliver rapid, self-titrated doses of nicotine to the human brain. However, smoking addiction is also sustained by non-nicotinic mechanisms as well. Sensorimotor experiences (e.g. mouth, hand, lung, visual, olfactory, etc.) provide significant reinforcement when coupled with nicotine surges. In some embodiments, the invention repeatedly exposes the user to non-nicotinic stimuli (sounds of a cigarette, visual representation of a cigarette, controlled deep breathing) to reinforce sensorimotor pleasures of smoking, mitigate cravings, and increase the likelihood of nicotinic uncoupling. Through this medium, both the executive and motivation systems can be systematically engaged through the multiple interaction modalities described, allowing users to remain calm and to control and systematically reduce and respond to cravings.

1-6. (canceled)

7. A system, comprising:
a computing device including one or more processors; and
a smoking cessation application stored in the memory and executable by the one or more processors, the smoking cessation application configured to decouple sensorimotor experiences of smoking experienced by a user from non-nicotinic reinforcers through initiation of a breathing exercise, the smoking cessation application including:
a breathing sound effects component configured to output, via an audio output, one or more breathing sound effects corresponding to a breathing pace representative of controlled breathing for a duration of the breathing exercise, the breathing sound effects including an inhaling sound effect and an exhaling sound effect;
a digital cigarette component configured to display, on a display of the computing device, a digital cigarette extending along a length of the display, the digital cigarette including a top portion that includes a lit portion of the digital cigarette and a bottom portion that includes a cigarette butt of the digital cigarette;
a haptic control component to provide sensorimotor engagement, the haptic control component configured to provide a haptic control bar extending horizontally across the digital cigarette, the haptic control bar configured to be guided along a predefined axis extending along a length of the digital cigarette to train the user to haptically follow the haptic control bar while the haptic control bar slides from the lit portion towards the cigarette butt and from the cigarette butt to the lit portion;
a breath capacity representation component configured to provide a graphical representation of breath capacity that changes appearance based on a movement of the haptic control bar, the graphical representation of breath capacity having a first appearance when the haptic control bar is positioned at the lit portion and having a second appearance when the haptic control bar is positioned at the cigarette butt;
wherein the initiation of the breathing exercise via the smoking cessation application includes providing non-nicotinic stimuli through a combination of moving the haptic control bar along the axis of the digital cigarette in synchrony with the breathing sound effects.

8. The system of claim 7, wherein the smoking cessation application includes a timer component configured to provide a timer indicating an amount of time lapsed from a beginning of the initiation of the breathing exercise or an amount of time remaining till an end of the breathing exercise.

9. The system of claim 7, wherein the haptic control bar slides between the lit portion and the cigarette butt at a speed corresponding to the breathing pace.

10. The system of claim 7, wherein the haptic control bar slides from the lit portion towards the cigarette butt at the same time the inhaling sound effect is output by the breathing sound effects component and the haptic control bar slides from the cigarette butt to the lit portion at the same time the exhaling sound effect is output by the breathing sound effects component.

11. The system of claim 7, wherein the graphical representation of breath capacity includes an image of at least one lung and an appearance of the at least one lung is based on a position of the haptic control bar relative to at least one of the cigarette butt or the lit portion.

12. The system of claim 7, further comprising a notification component configured to generate and deliver messages to the user at predetermined times and receive, from the user, feedback on at least one message of the delivered messages indicating an efficacy of the message.

13. A system comprising:
a computing device including one or more processors; and
a smoking cessation application stored in the memory and executable by the one or more processors, the smoking cessation application including
a sensorimotor decoupling component configured to decouple sensorimotor experiences of smoking experienced by a user from non-nicotinic reinforcers through initiation of a breathing exercise, the sensorimotor decoupling component including
a breathing component configured to provide a breathing indicator corresponding to a breathing pace representative of controlled breathing for a duration of the breathing exercise, the breathing indicator including a first effect representative of an inhaling phase and a second effect representative of an exhaling phase;
a haptic control component to provide sensorimotor engagement, the haptic control component configured to provide a haptic control bar, the haptic control bar configured to be guided along a predefined axis to train the user to haptically follow the haptic control bar along the predefined axis;
a breath capacity representation component configured to provide a graphical representation of breath capacity that changes appearance based on a movement of the haptic control bar, the graphical representation of breath capacity having a first appearance when the haptic control bar is positioned at a first position along the predefined axis and having a second appearance when the haptic control bar is positioned at a second position along the predefined axis;
wherein the initiation of the breathing exercise via the smoking cessation application includes providing non-nicotinic stimuli through a combination of moving the haptic control bar along the predefined axis in synchrony with the breathing indicator;
a notification component configured to generate and deliver messages to the user at predetermined times and receive, from the user, feedback on at least one message of the delivered messages indicating an efficacy of the message; and
a metrics component configured to calculate a total number of cigarettes avoided, a financial savings value and a lifespan adjustment value by the user based on performing the breathing exercise.

14. The system of claim 13, wherein the smoking cessation application includes a timer component configured to provide a timer indicating an amount of time lapsed from a beginning of the initiation of the breathing exercise or an amount of time remaining till an end of the breathing exercise.

15. The system of claim 13, wherein the haptic control bar slides between the first position and the second position at a speed corresponding to the breathing pace.

16. The system of claim 13, wherein the haptic control bar slides the first position towards the second position at the same time the first effect is output by the breathing component and the haptic control bar slides from the second position towards the first position at the same time the second effect is output by the breathing component.

17. The system of claim 13, wherein the graphical representation of breath capacity includes an image of at least one lung and an appearance of the at least one lung is based on a position of the haptic control bar relative to at least one of the first position or the second position.

18. The system of claim 13, wherein the smoking cessation application includes a timer component configured to provide a timer indicating an amount of time lapsed from a beginning of the initiation of the breathing exercise or an amount of time remaining till an end of the breathing exercise.

19. The system of claim 13, wherein the financial saving value is calculated based on a product of the number of cigarettes avoided and a price of a cigarette and the lifespan adjustment value is calculated based on the number of cigarettes avoided.

20. The system of claim 13, wherein the notification component is further configured to identify an anticipated craving window of the user and deliver at least one message of the messages to the user responsive to identifying the anticipated craving window.

21. A method comprising:
executing, by a computing device including one or more processors, a smoking cessation application configured to decouple sensorimotor experiences of smoking experienced by a user from non-nicotinic reinforcers through initiation of a breathing exercise, wherein executing the smoking cessation application includes
outputting, by a breathing sound effects component of the smoking cessation application, one or more breathing sound effects corresponding to a breathing pace representative of controlled breathing for a duration of the breathing exercise, the breathing sound effects including an inhaling sound effect and an exhaling sound effect;
displaying, by a digital cigarette component of the smoking cessation application, on a display of the computing device, a digital cigarette extending along a length of the display, the digital cigarette including a top portion that includes a lit portion of the digital cigarette and a bottom portion that includes a cigarette butt of the digital cigarette;
providing, by a haptic control component of the smoking cessation application to provide sensorimotor engagement, a haptic control bar extending horizontally across the digital cigarette, the haptic control bar configured to be guided along a predefined axis extending along a length of the digital cigarette to train the user to haptically follow the haptic control bar while the haptic control bar slides from the lit portion towards the cigarette butt and from the cigarette butt to the lit portion;
providing, by a breath capacity representation component of the smoking cessation application, a graphical representation of breath capacity that changes appearance based on a movement of the haptic control bar, the graphical representation of breath capacity having a first appearance when the haptic control bar is positioned at the lit portion and having a second appearance when the haptic control bar is positioned at the cigarette butt;
wherein the initiation of the breathing exercise via the smoking cessation application includes providing non-nicotinic stimuli through a combination of moving the haptic control bar along the axis of the digital cigarette in synchrony with the breathing sound effects.

22. The method of claim 21, wherein executing the smoking cessation application further includes providing, for display, a timer indicating an amount of time lapsed from a beginning of the initiation of the breathing exercise or an amount of time remaining till an end of the breathing exercise.

23. The method of claim 21, wherein the haptic control bar slides between the lit portion and the cigarette butt at a speed corresponding to the breathing pace.

24. The method of claim 21, wherein the haptic control bar slides from the lit portion towards the cigarette butt at the same time the inhaling sound effect is output by the breathing sound effects component and the haptic control bar slides from the cigarette butt to the lit portion at the same time the exhaling sound effect is output by the breathing sound effects component.

25. The method of claim 21, wherein the graphical representation of breath capacity includes an image of at least one lung and an appearance of the at least one lung is based on a position of the haptic control bar relative to at least one of the cigarette butt or the lit portion.
